(19) United States
(12) Patent Application Publication
(10) Pub. No.: US 2008/0254253 A1
(43) Pub. Date: Oct. 16, 2008

(54) Interchangeable and removably connected geometric carpet sections

(76) Inventor: Michael Gallager, (US)

Correspondence Address: Cleveland R. Williams, Suite #100, 2501 E. Chapman Ave., Fullerton, CA, 92831, US

(21) Appl. No.: 11/786,557

(22) Filed: Apr. 12, 2007

(51) Int. Cl. B32B 33/00

(52) U.S. Cl. 428/86

(57) ABSTRACT

Interchangeable and removably connected geometric carpet sections or runners that are suitable for use in homes, commercial buildings, industrial buildings, and the like are described. The carpet sections have geometric configurations wherein the various sections are removably joined together to follow a given path or direction. Alternatively, a plurality of stair step modules, contain carpet sections, which are attached to stair steps are disclosed.

### BACKGROUND OF THE INVENTION

1. Field of the Invention

The present invention relates to interchangeable and removably connected geometric carpet sections or runners that are suitable for use in commercial buildings, industrial buildings, private homes and the like.

The carpet sections comprise a variety of geometric shapes that form a runner or section of carpet especially designed to follow a given path or direction. The carpet sections are removably held in place by Velcro® strips, which connect two carpet sections together. When several geometric carpet sections are attached together in sequential order, the carpet sections can be formed into a carpet strip having a desired configuration for a particular section of a substrate, such as a floor.

An alternate mode of the current invention involves a plurality of plastic modules for stairs that are particularly designed to be attached to and removed from stair steps. The modules contain removably attached sections of carpet that are held in place by Velcro®, clips or screws.

2. Description of the Prior Art

Purchasing, installing and maintaining floor coverings such as carpet, tile, vinyl or other materials that traditionally cover a substrate such as floor require a major investment in time, labor and material costs. Over a period of time, normal use wears out a floor covering or specified sections thereof.

Replacing only a portion of the floor covering or only the wear surfaces would solve this problem. However, this process is costly and time consuming.

Thus, there is a need for modular flooring systems and processes for quickly and efficiently interchanging modular sections of a carpet.

For example, U.S. Pat. No. 6,694,689 B1 to Scott et. al. describes modular flooring systems and methods using one or a plurality of free-lay support modules. The free-lay support module includes a base plate and a frame member having a first arm and a second arm that meet and form an angle. Replaceable wear surface modules with or without a backing structure fit within the base plate. The replaceable wear surface modules may be carpet, carpet tile, vinyl flooring, wood flooring, etc.

U.S. Pat. No. 5,804,273 to Drake Jr., et. al. teaches wall to wall carpeting that is applied directly over worn broadloom or tile carpeting having a backing secured to a hard floor surface and a top pile surface. The carpeting is secured to the surface with an adhesive.

The worn carpet is cleaned and a high molecular weight acrylic ester polymer emulsion adhesive is sprayed onto the top pile surface of the old carpet. A vinyl backing of one or more new carpet strips is applied to the adhesive. The carpet strips include holding strips of hook fasteners. The new carpet backing to be placed over the worn carpet may include loop fasteners, which corporate and engage the hook fasteners and hold the new carpet in place.

U.S. Pat. No. 5,683,780 to Rodgers et. al. relates to a novel modular carpet tile mat construction and a process for making the same. The mat comprises a mat base composed of woven or spun-bonded polyester nylon or polypropylene (a) a woven or spun-bonded polyester nylon or polypropylene fibre mat; (b) a plastic binder enveloping the fibre mat and binding the fibres of the mat together; (c) a first layer of resilient expanded or foamed polymer or rubber distinct from the plastic binder and (d) a second layer of resilient expanded or foamed polymer or rubber distinct from the plastic binder and adhered to the second side of the plastic-enveloped woven or spun-bonded fibre mat.

U.S. Pat. No. 6,740,380 B2 to Kessler describes a floor mat system having a plurality of floor mats disposed in edge-to-edge relationships. The floor mats are held in place with clips that prevent the mats from creeping over each other while allowing the mats to be lifted from the floor. Each mat is held down with four clips disposed at the corners of the floor mat. Another embodiment provides mats held in place with clips positioned at the center of the mats.

As can be seen from the foregoing, there is an ongoing search for new and novel methods for installing new and replacing worn carpeting in a building, for example a house.

### SUMMARY OF THE INVENTION

The present invention resides in interchangeable and removably connected geometric carpet sections or runners that are suitable for use in a variety of buildings.

The carpet sections comprise a variety of geometrical shapes having various angles that combine to form a runner or section of carpet especially designed to follow a given path or direction. The carpet sections are removably held together or in place by Velcro® strips which connect two or more carpet sections together.

An alternate mode of the invention resides in a plurality of plastic modules for removably attaching to stair steps. The plastic modules contain Velcro® for removably attaching sections of carpet to the plastic modules.

### BRIEF DESCRIPTION OF THE DRAWINGS

The invention will be better understood when consideration is given to the below-described detail description, which makes reference to the amended drawings wherein:

FIG. 1 is a front perspective, exploded view of a set of stair steps and a plurality of stair steps modules connected thereto.

FIG. 2 is another view of FIG. 1 with complete carpet sections attached to a plurality of stair step modules wherein the modules contain side moldings.

FIG. 3 is a view substantially the same as the view in FIG. 2 with the exception that molding is replaced by thin, flexible waterproof LED lighting enclosed by flexible PVC.

FIG. 4 is a side cut-away view of a stair step module containing removable connected carpet sections.

FIG. 5 is yet another side cut-away view of a stair step module containing carpet sections.

FIG. 6 is a front cut-away view of carpet having molding along the edge thereof.

FIG. 7 is a front perspective view of stair steps having geometric carpet sections leading from the bottom step in a preconceived arrangement and direction.

FIG. 8A is a side view of two carpet sections that are interconnected by a connecting strip which has projections thereon which engage mating projections on the outer surfaces of the carpet sections wherein one of the carpet sections is not engaged.

FIG. 8B is another view of FIG. 8A wherein both sections of the carpet are fully engaged with connecting strip.

FIG. 9A is a top view of a rectangular shaped carpet section having a V-shaped cut out on one end and is truncated on the opposite end.

FIG. 9B is a top view of a carpet section that has a cup like configuration with a triangle superimposed on the top section thereof.

FIG. 9C is a top view of a carpet section that has a triangular configuration that is truncated on one end.

FIG. 10A is a top view of a carpet section having a circular configuration defined by a 90° angle.

FIG. 10B is a top view of a carpet section having a circular configuration defined by 45° angle.

FIG. 10C is a top view of a carpet section having a circular configuration defined by a 22½° angle.

FIG. 11A is a top view of a carpet section having a rectangular shaped configuration.

FIG. 11B is a top view of a carpet section having an elongated cross-shaped configuration.

FIG. 11C is a top view of a carpet section having a T-shaped configuration.

### DETAILED DESCRIPTION OF THE INVENTION

Embodiments of the geometric carpet sections and/or the plurality of stair step modules are herein described with reference to the drawings, in which identical or corresponding parts are indicated by the same reference characters or numbers through the several views.

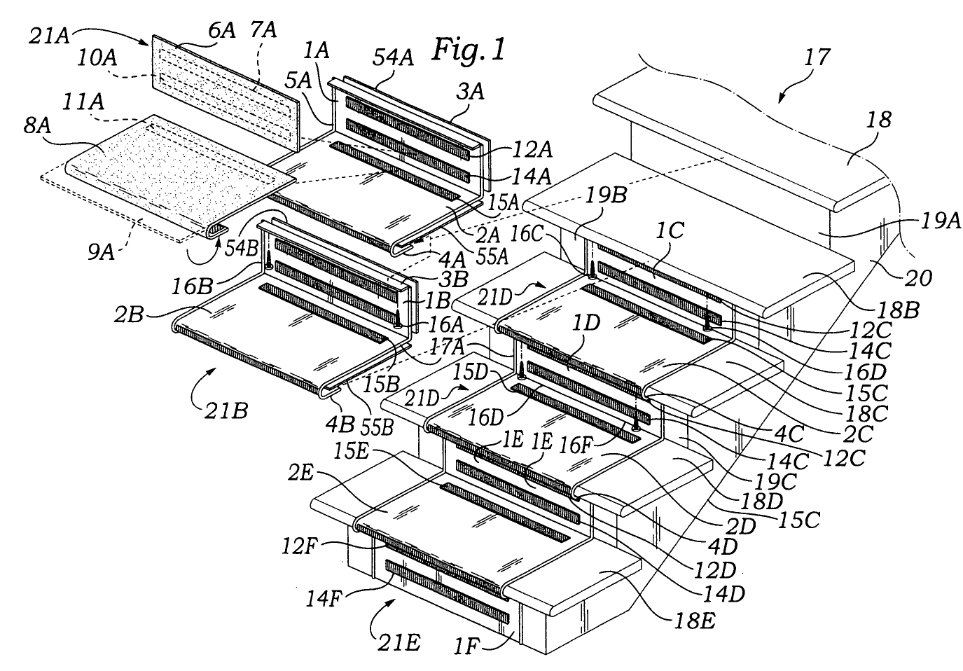

FIG. 1 is a front perspective, exploded view of a stair step case wherein a plurality of stair step modules are connected to the stair steps. Carpet sections are removably connected to the stair step modules.

The plurality of modules 21A to 21F, contain vertical panels 1A to 1F and horizontal panels 2A to 2F. Vertical panel 1A, which is representative of all the vertical panels has a rectangular shape with an upper inverted L-shaped lip 3A near the top section thereof. Vertical panel 3A contains strips 12A and 14A which have projections thereon for engaging strips 7A and 10A connected to carpet section 6A having mating projections thereon. The mating projections are manufactured and sold under the tradename and trademark Velcro®. Carpet section 6A has a rectangular shaped configuration.

Horizontal panel 2A, which is representative of all the horizontal panels herein has a rectangular shape with downward shaped lip 4A which turns downward and under the front horizontal section of stair step 18A.

Horizontal panel 2A contains strip 15A which has projections thereon for engaging strip 11A connected to carpet section 8A. Carpet section 8A is rectangular in shape and curves around section 4A of horizontal panel 2A at location 9A of said carpet section.

Screws 16C and 16D are representative of the screws herein. Screws 6C and 6D connect horizontal panel 2A to the horizontal part of stair step 18A where downward shaped lip 4A interlocks with the inverted upper L-shaped lip of the vertical panel 1A. Horizontal panels 2A and 2B and vertical panels 1A and 2A which are representative of all the horizontal and vertical panels herein contain panel backings 55A and 55B and 54A and 54B respectively. The backings can be constructed from rubber, matting or a similar material. The purpose of the backing is to protect the stair steps from collateral damage during use of the modules.

Horizontal panel 2A is superimposed over horizontal stair step 18A wherein downward shaped lip 4A wherein screws 16C and 16D secure lip 4A to the underside of stair step 18A.

Stair step modules 21A to 21F including vertical panels 6A to 6F and horizontal panels 8A to 8F can be constructed from rigid polyvinyl chloride (PVC), hardened rubber or plastics commonly known as acrylonitrile butadiene styrene (ABS). It should be noted that vertical panels 1B to 1F have substantially the same features of vertical panel 1A, and horizontal panels 2B to 2F have substantially the same features as horizontal panel 2A. Similarly carpet sections 6B to 6F (not shown) have substantially the same features as carpet section 6A and carpet sections 8B to 8F (not shown) have substantially the same features of carpet section 8A.

It should be noted that the typical stair step case contains from about 2 to about 30 stair step modules, 21A to 21F especially from about 2 to about 20 stair step modules 21A to 21F.

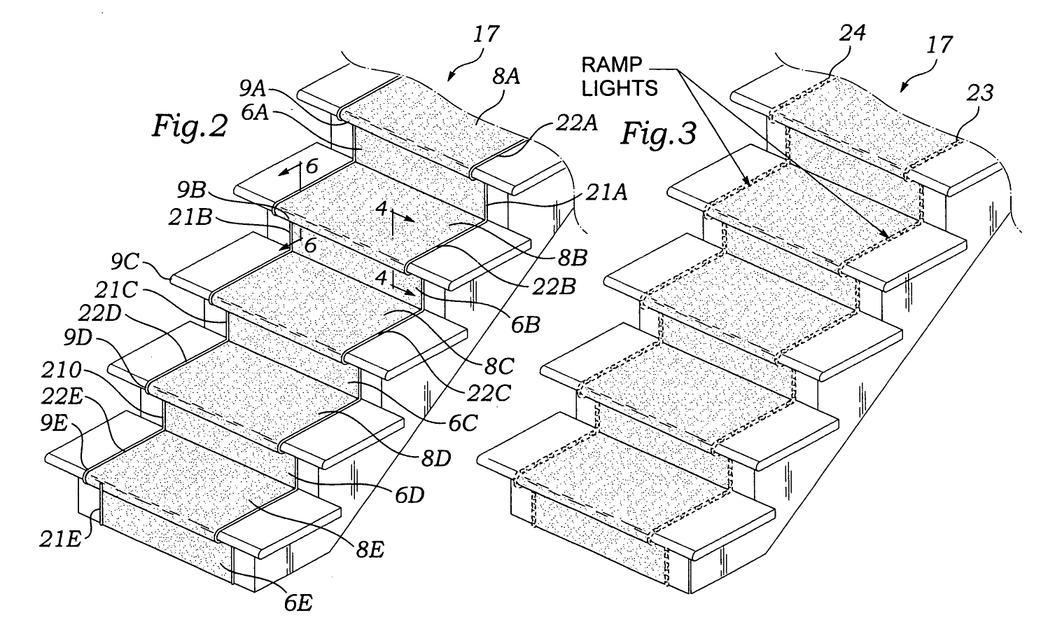

FIG. 2 is another view of FIG. 1 which has horizontal and vertical carpet sections 6A to 6E connected to the respective vertical and horizontal panel sections. Side molding 22A to 22E are side moldings that attach to the sides of horizontal panels 8A to 8E and side moldings 21A to 21E attach to the sides of vertical panels 6A to 6E.

The side moldings have circular shapes or configurations and are constructed from rigid polyvinyl chloride (PVC), hardened rubber, or plastics commonly known as (ABS). The moldings may be attached to the carpet sections using adhesives, staples and the like, or be an integral part molded onto the sides of said panel.

FIG. 3 is another view of FIG. 2 with the following exception: the side molding for the horizontal and vertical panels are replaced by low-voltage, low power consumption SME (surface mount-divide) LEDs 23 and 24.

The LEDs preferably enclosed in pliable transparent polycarbonate materials and are contained in thin, flexible transparent PVC enclosures which conform to any profile. The PVC enclosures are either rectangular in configuration or circular in configuration. The LEDs have a power source such as an electrical outlet in a house and a Class II LED transformer SLD series which transforms 120 volt AC current to 12 volt DC current. The LED's preferably have lights that are selected from the color group of white, red, yellow, green and blue and mixtures thereof. The LED lights have spacings of from 1 inch to 12 inches apart especially from 2, 3, 4, 6, or 12 inches apart and the polycarbonate and polyvinyl chloride enclosures bend up to 180° and conform to any profile. The LEDs are secured to the horizontal panels and vertical panels with adhesives or double sided tapes manufactured and marketed by the 3M Company.

It should be noted that the average staircase in a residence contains from 2 to about 30 stair steps, especially from 2 to about 20 stair steps.

Ramp lights 23 and 24 preferably are located on the outer side edges of the horizontal and vertical panels wherein said ramp lights are parallel to each other. It should be noted that the ramp lights can be located from 2 inches to 4 inches from the edge of the horizontal panels toward the central planes thereof. When the ramp lights are located inward from 2 to 6 inches from the edges of the horizontal and vertical panels, carpet sections 8A to 8E and 6A to 6E are positioned inside the space between ramp lights 23 and 24 and from the outer edge of ramp lights 23 and 24 to the outer edge of horizontal panels 2A to 2E and vertical panels 1A to 1E.

When the carpet sections are located in between and on both sides of ramp lights 23 and 24 the carpet edges can contain sewn sides consisting of polyester, cotton, synthetic edging or nylon. The ramp lights can additionally be secured under the stair steps by clips having a U-shaped configuration with side wings for receiving screws.

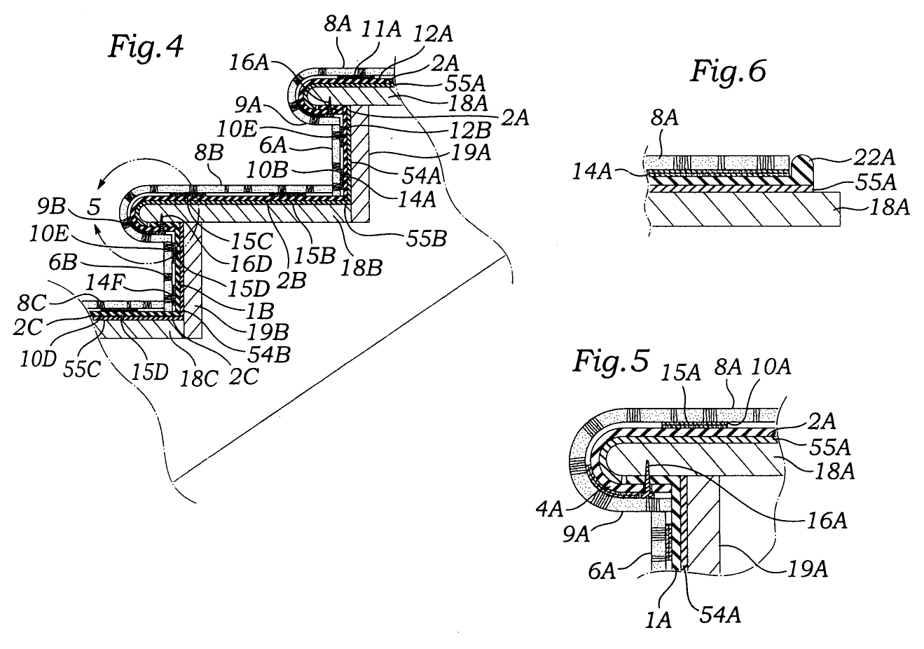

FIG. 4 is a side cut away view of the first two stair steps in FIG. 1, wherein carpet section 8A is superimposed on horizontal panel 2A and is held in place by strip 10 which has mating projections which mate with projections on strip 15A. Horizontal panel 2A is superimposed on horizontal step 18A and held in place by screw 16A. Carpet 8A bends around lower lip 4A of horizontal panel 2A at bend location 9A. Lower lip 4A extends backward and engages lip 3A of vertical panel 1A. Vertical carpet section 6A is superimposed over vertical panel 1A and is held in position by strips 12A and 14A located on vertical panel 1A and strips 7A and 10B located on carpet section 6A. Strips 12A and 14A have projectiles which engage and mate with mating projectiles on strips 10B and 10C releasably connecting carpet section 8B to horizontal panel 3B. Screw 16D connects horizontal panel 2B to the underside of horizontal stair step 18A. Stair step 19B and 18C with horizontal panel 2C and vertical panel 1B, carpet sections 6B and 8C are connected to vertical panel 1B and horizontal panel 2C substantially the same as described above utilizing screw 16D and mating projection strips 12D and 14D with projection strips 7D and 10D.

FIG. 5 is a close-Lip, cross section, cut-away view of the top horizontal step 18A and vertical section 19A of said step, wherein stair step module 21A is superimposed over horizontal step 18A and vertical section 19A. Horizontal panel 2A has downward shaped lip 4A which bends around front section 8A and engages the inverted L-shaped top lip of vertical panel 1A. Carpet section 8A is superimposed over horizontal panel 2A and bends around section 4A at bend 9A. Carpet section 8A contains strip 11A having mating projections and is attached to then underside of carpet 8A adhesives. Vertical panel 1A is superimposed over vertical stair step section 19A and contains vertical strip 12A having mating projections which mate with strip 7A which is attached to the underside of carpet 8A. Strip 12A and strip 7A are attached to the front of vertical panel 1A and the back of carpet section 6A respectively. Protective padding 55A is located between horizontal panel 2A and horizontal stair step 18A.

FIG. 6 is a side, cut-away view of horizontal stair step 18A with horizontal panel 2A superimposed over it. Horizontal strip 14A having mating projections is adhesively attached to the top section of vertical panel 2A on the bottom side thereof.

Horizontal strip 11A which has mating projections is adhesively attached to the underside section of carpet 8A where it is mated with horizontal strip 14A.

It should be noted that vertical panels 1A and 1B have a layer of protective padding 54A and 54B between said vertical panels and vertical stair steps 19A and 19B. Similarly horizontal panels 2A to 2C have a layer of protective padding 55A to 55C between said horizontal panels and horizontal stair steps 18A to 18C.

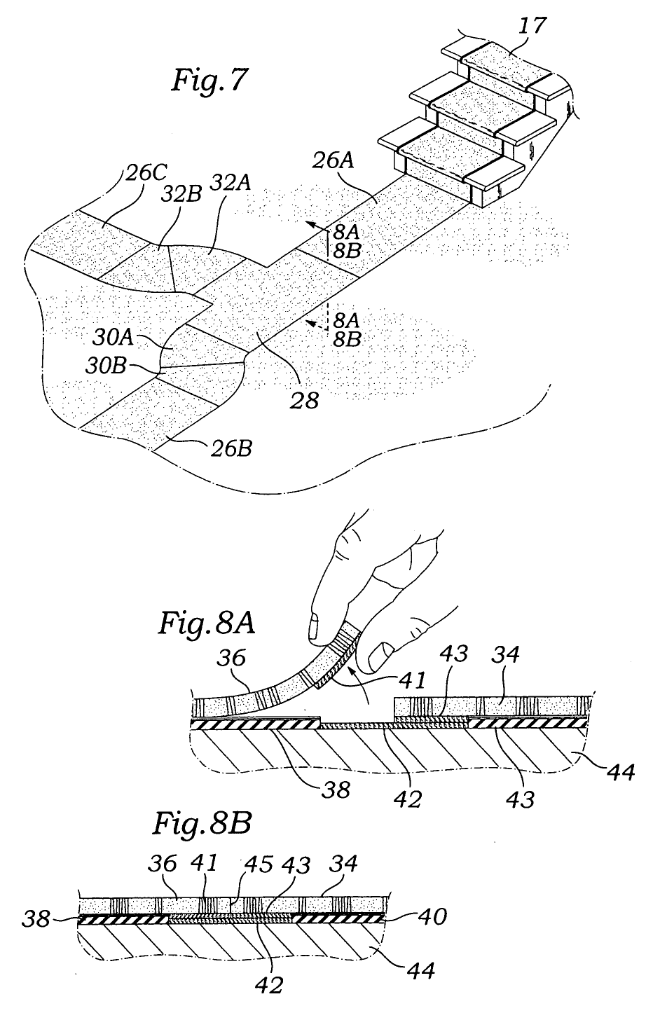

FIG. 7 is a top, perspective view of staircase 17 which contain geometric carpet sections which are removably connected ton each other in a desired configuration. Rectangular carpet section 26A is located at the bottom of staircase 17 along plane 8A and 8B. T-shaped carpet section 28 is attached to rectangular shaped carpet section 26A at one end and to circular shaped carpet section 30A at the other end. Circular carpet section 30B is rotated 180° from carpet section 30A and is attached thereto at one end and to rectangular carpet section 26B at the opposite end.

Circular shaped carpet section 32A is attached to the T-section of T-shaped carpet section 28 at one end. Circular shaped carpet section 32B is rotated 180° from circular shaped carpet section 32A is attached to opposite end thereof. Rectangular shaped carpet section 26C is attached to the end of circular shaped carpet 32B.

FIG. 8A shows carpet section 36 in an unmated position being lifted up by an individual's hand 54. Carpet backing 38 is adhesively attached to the underside of carpet 36. Mating strip 41 having mating projections therein is adhesively attached to the underside of carpet 41 at one end. Mating strip 42 is twice as wide as mating strip 41, wherein both strips have mating projections that removably mate with each other. Carpet section 34 contains carpet backing 43 which is adhesively attached to the underside of carpet section 34.

Mating strip 43 is attached to the underside of carpet section 34 and has downward mating projections which have mated with one half of mating strip 42. It should be noted that the carpet backing is constructed from conventional carpet backing, for example, rubber or matting. The carpet backing 38 and 43 and mating strip 42 are overlaid on floor 44.

FIG. 8B is substantially the same as FIG. *A with the following exception: mating strip 41 of carpet section 36 is in a mating position with mating strip 42.

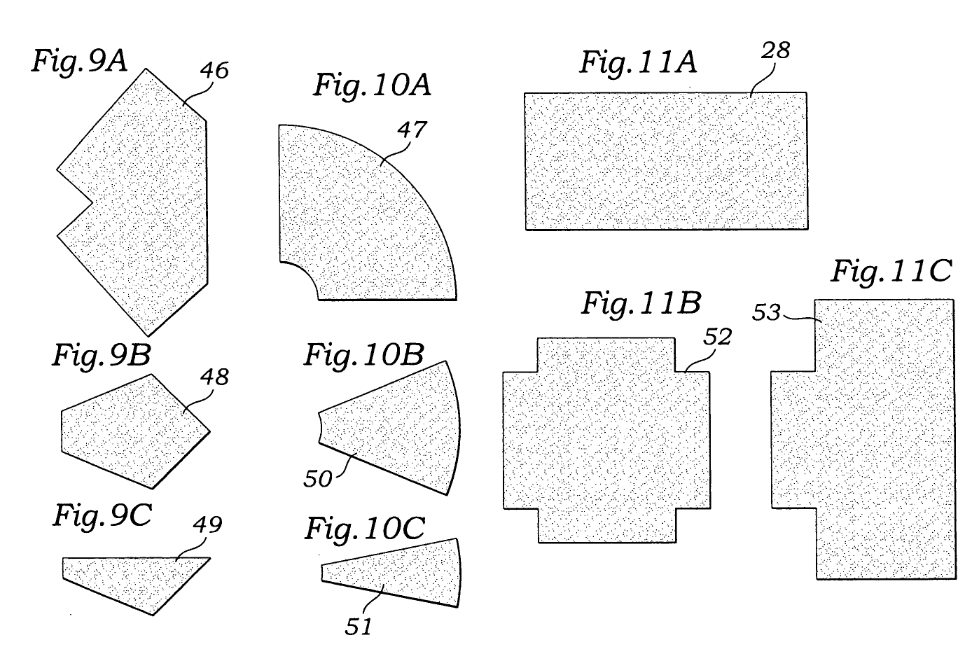

FIGS. 9A through 11C are top views of the shapes of desirable geometric carpet sections which are suitable use herein.

FIG. 9A is a top view of a rectangular shaped carpet section having an n L-shaped cut out on one end and is truncated on the opposite end.

FIG. 9B is a top view of a carpet section that has a cup like configuration with a triangle superimposed on the top section thereof FIG. 9C is a top view of a carpet section that has a triangular configuration that is truncated on one end.

FIG. 10A is a top view of a carpet section having a circular configuration defined by a 90° angle.

FIG. 10B is a top view of a carpet section having a circular configuration defined by 45° angle.

FIG. 10C is a top view of a carpet section having a circular configuration defined by a 22½° angle.

FIG. 11A is a top view of a carpet section having a rectangular shaped configuration.

FIG. 11B is a top view of a carpet section having an elongated cross-shaped configuration.

FIG. 11C is a top view of a carpet section having a T-shaped configuration.

Obviously, many modifications and variations of the invention, as herebefore set forth, may be made without departing from the spirit and scope thereof, and therefore, only such limitations should be imposed as are indicated in the appended claims.

I claim:

1. Interchangeable and removeably connected geometric carpet sections which comprise a plurality of stair step modules connected to stair step case wherein each stair step module contains a rectangular-shaped, vertical panel having an upper inverted L-shaped lip near the upper portion thereof and a rectangular-shaped, horizontal panel containing a downward shaped lip which turns downward and under a front horizontal portion of a stair step, wherein said vertical panel contains a removably connected rectangular shaped carpet section and said horizontal panel contains a removably connected rectangular-shaped carpet section.

2. The interchangeable and removably connected geometric carpet sections of claim 1, wherein the rectangular-shaped, vertical panel is superimposed over a vertical section of a stair step, wherein the vertical panel has removable and connections means.

3. The interchangeable and removably connected geometric carpet sections of claim 2, wherein the removable and connection means comprise screws that attach the inverted L-shaped, lip of the vertical panel to the front section of a stair step.

4. The interchangeable and removably connected geometric carpet sections of claim 1 wherein a rectangular shaped carpet section is removably connected to the vertical panel by a connecting strip connected to the panel which has projection thereon which engage mating projections on strips connected to the carpet sections.

5. The interchangeable and removably connected geometric carpet sections of claim 1, wherein rectangular-shaped, horizontal panel is superimposed over a horizontal section of stair step, wherein the horizontal panel has removal and connection means.

6. The interchangeable and removably connected geometric carpet sections of claim 5, wherein the removable and connection means comprise screws that attach the downward shaped lip to the front, bottom section of a stair step.

7. The interchangeable and removably connected geometric carpet sections of claim 1, wherein the downward shaped lip of the horizontal panel, curves around and under the front section of a stair step and engages the top section of the inverted L-shaped lip of the vertical panel.

8. The interchangeable and removably connected geometric sections of claim 1, wherein the back section of a horizontal panel contacts the lower portion of a vertical panel.

9. The interchangeable and removably connected geometric carpet sections of claim 1, wherein a rectangular shaped carpet section is removably connected to the horizontal panel by a connecting strip connected to the panel which has projections thereon which engage mating projections on strips connected to the carpet sections.

10. The interchangeable and removably connected geometric carpet sections of claim 1, wherein a rectangular shaped carpet sections contain side molds.

11. The interchangeable and removably connected geometric carpet sections of claim 1, wherein carpet sections on the stair step modules contain ramp lights.

12. The interchangeable and removably connected geometric carpet sections of claim 11, wherein the ramp lights are low-voltage, low power consumption LED's.

13. The interchangeable and removably connected geometric carpet sections of claim 12, wherein the ramp lights are enclosed in a thin, transparent and flexible PVC enclosure.

14. The interchangeable and removably connected geometric carpet sections of claim 13, wherein the PVC enclosure has an elongated circular configuration.

15. The interchangeable and removably connected geometric carpet sections of claim 13, wherein the PVC enclosure has an elongated rectangular configuration.

16. Interchangeable and removably connected geometric carpet sections which comprise geometric carpet sections having upper carpet portions and bottom rubber backings, the bottoms of said carpet sections containing strips having projections connected to the bottom of said carpet sections for receiving connecting strips which engage the projections on the strips attached to the carpet sections wherein the connecting strips are twice as wide as the strips attached to the carpet sections.

17. The interchangeable and removably connected geometric carpet sections of claim 16, wherein the strips are attached to the carpet sections utilizing a tape having an adhesive on both sides.

18. The interchangeable and removably connected geometric carpet sections of claim 16, wherein the geometric carpet sections are selected from the group consisting of rectangular, T-shaped, and cross shaped configurations.

19. The interchangeable and removably connected geometric carpet sections of claim 16, wherein the geometric carpet sections are selected from the group consisting of circular configurations which are defined by angles of from 22° to 90°.

20. The interchangeable and removably connected geometric carpet sections of claim 16, wherein the geometric carpet sections are selected from the group consisting of a rectangular shaped carpet section having an L-shaped cut out on one end and is truncated on the opposite end, a cup-like configuration carpet section with a triangle superimposed on the top thereof and a carpet section having a triangular configuration that is truncated at one end.
